(19) United States
(12) Patent Application Publication
(10) Pub. No.: US 2026/0058237 A1
(43) Pub. Date: Feb. 26, 2026

(54) Retaining device for rechargeable cells

(71) Applicant: Hilti Aktiengesellschaft, Schaan (LI)

(72) Inventors: Daniel SELTMANN, Landsberg am Lech (DE); Markus HARTMANN, Mauerstetten (DE); Rory BRITZ, Starnberg (DE); Robert STANGER, Kaufbeuren (DE); Klaus HAUSER, Schwabmünchen (DE); Mathias FRENZEL, Unterdießen (DE); Moses ENDER, Kaufering (DE)

(21) Appl. No.: 19/102,925

(22) PCT Filed: Aug. 21, 2023
(86) PCT No.: PCT/EP2023/072935

§ 371 Date: Feb. 11, 2025

(30) Foreign Application Priority Data
Sep. 2, 2022 (EP) 22193668.5

(51) Int. Cl. H01M 10/6235; B25F 5/02; H01M 10/613; H01M 10/6551; H01M 10/656; H01M 50/247

(52) U.S. Cl. CPC H01M 10/6235; H01M 10/613; H01M 10/6551; H01M 10/656; H01M 50/247; B25F 5/02; H01M 2220/30

(57) ABSTRACT

Rechargeable battery as an energy supply for a power tool with at least a first and a second energy storage element. At least a first retaining device for receiving and retaining the at least first energy storage element and at least a second retaining device for receiving and retaining the at least second energy storage element is included, wherein at least a subregion of an outer surface of the at least first and/or second retaining device is configured such that at least one gap for a cooling fluid is provided between adjacent retaining devices. Power tool with at least one rechargeable battery.

The present invention relates to a rechargeable battery as an energy supply for a power tool with at least a first and a second energy storage element.

It furthermore relates to a power tool with at least one rechargeable battery.

### BACKGROUND

Rechargeable batteries are widely known in the prior art as an energy supply for a power tool. These rechargeable batteries include a number of energy storage cells (also referred to as rechargeable cells), which serve and are designed to receive, store, and deliver electrical energy. The receiving of electrical energy into the energy storage cells can also be referred to as charging (or loading). The delivery of electrical energy from the energy storage cells can also be referred to as discharging.

### SUMMARY OF THE INVENTION

A problem when using the rechargeable battery, i.e. when charging and discharging, is the undesired or unavoidable heating of the energy storage cells. Because of the heating of the energy storage cells, the charging and discharging does not proceed optimally or the charging and discharging procedure is slowed down significantly.

It is an object of the present invention to solve the problem described above.

The present invention provides a rechargeable battery as an energy supply for a power tool with at least a first and a second energy storage element.

At least a first retaining device for receiving and retaining the at least first energy storage element and at least a second retaining device for receiving and retaining the at least second energy storage element is included, wherein at least a subregion of an outer surface of the at least first and/or second retaining device is configured such that at least one gap for a cooling fluid is provided between adjacent retaining devices. Effective cooling of the energy storage elements can be achieved as a result.

According to an advantageous exemplary embodiment, it can be possible that at least a first retaining device for receiving and retaining the at least first energy storage element and at least a second retaining element for receiving and holding the at least second energy storage element is included, wherein at least a subregion of an outer surface of the at least first and/or second retaining device is configured such that at least one gap for a cooling fluid is provided between adjacent retaining devices.

According to a further advantageous exemplary embodiment, it can be possible that at least one frame apparatus for receiving and retaining the at least first and second retaining device is included. The energy storage elements can additionally be supported or held in position in the retaining devices as a result.

According to a further advantageous exemplary embodiment, it can be possible that the at least first and second retaining device are connected to each other by means of a connecting device. Mutual support of the retaining devices can be achieved by the connecting device. Furthermore, a plurality of retaining devices can be connected to one another before the positioning inside a housing of the rechargeable battery such that the rechargeable battery can be mounted more quickly and efficiently.

According to a further advantageous exemplary embodiment, it can be possible that the connecting device is configured such that the at least first and second retaining device are connected releasably to each other. A modular and flexible connection of the retaining devices relative to each other or mounting of the rechargeable battery can be achieved as a result.

According to a further advantageous exemplary embodiment, it can be possible that the connecting device is configured such that the at least first and second retaining device are connected rigidly to each other. A stable and robust connection of the retaining devices relative to each other, which can withstand a high mechanical load, can be achieved as a result.

According to a further advantageous exemplary embodiment, it can be possible that at least one cooling element is included at at least one subregion of an outer surface of the first and/or second retaining device. Improved cooling performance can be achieved as a result.

According to a further advantageous exemplary embodiment, it can be possible that at least one cooling element is configured as a cooling rib. Improved cooling performance can be achieved as a result in a simple and effective way.

According to a further advantageous exemplary embodiment, it can be possible that the at least first and/or second retaining device includes a polygonal outer surface. As a result, the positioning of adjacent retaining devices relative to each other can be facilitated and a multidirectional arrangement of the retaining devices relative to each other achieved,

According to a further advantageous exemplary embodiment, it can be possible that the at least first retaining device has a first embodiment of an outer surface and the at least second retaining device has a second embodiment of an outer surface. It is in particular possible that retaining devices which are positioned on a side face of the housing of the rechargeable battery have no or only smaller cooling elements at least on an outer surface. The corresponding retaining device can be positioned more closely or tightly to the side face of the housing of the rechargeable battery as a result.

The present invention provides a power tool according to the invention with at least one rechargeable battery. DR

### BRIEF DESCRIPTION OF THE DRAWING

Further advantages will become apparent from the following description of the figures. A particularly preferred exemplary embodiment of the present invention is illustrated in the figures. The figures, the description, and the claims contain numerous features in combination. A person skilled in the art will expediently also consider the features individually and combine them to form sensible further combinations.

Identical and similar components are denoted by the same reference signs in the figures, in which:

FIG. 1 shows a side view of a power tool with a rechargeable battery;

FIG. 2 shows a perspective view of retaining devices according to a first embodiment for receiving and retaining energy storage elements;

FIG. 3 shows a front view of retaining devices according to a second embodiment;

FIG. 4 shows a front view of retaining devices according to a second embodiment in a housing of the rechargeable battery;

FIG. 5 shows a front view of retaining devices according to a third embodiment in a housing of the rechargeable battery;

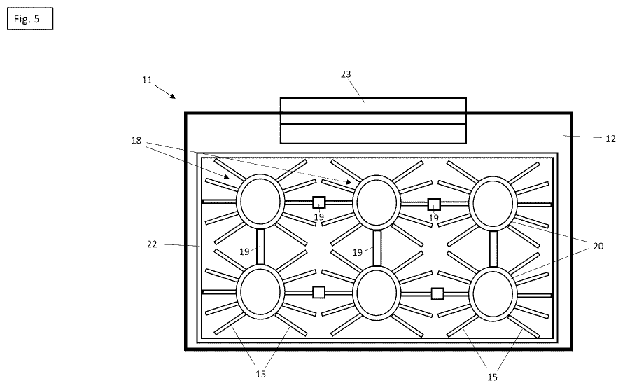

FIG. 6 shows a front view of retaining devices according to a fourth embodiment in the housing of the rechargeable battery;

FIG. 7 shows a perspective view of retaining devices according to the fourth embodiment in the housing of the rechargeable battery;

FIG. 8 shows a perspective view of retaining devices according to a fifth embodiment in the housing of the rechargeable battery;

FIG. 9 shows a perspective view of retaining devices according to a sixth embodiment in a first arrangement;

FIG. 10 shows a perspective view of retaining devices according to the sixth embodiment in a second arrangement;

FIG. 11 shows a perspective view of retaining devices according to a seventh embodiment in a first arrangement; and

FIG. 12 shows a perspective view of retaining devices according to the seventh embodiment in a second arrangement.

### DETAILED DESCRIPTION

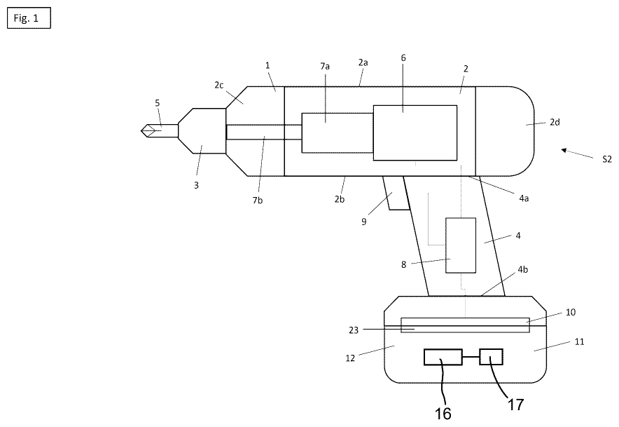

FIG. 1 shows a power tool 1 and a rechargeable battery 11 according to an exemplary embodiment.

The power tool 1 is configured as a screwdriver in the embodiment shown. Alternatively, the power tool 1 can also be configured as a power drill, a hammer drill, a saw, a grinder, or the like.

As indicated in FIG. 1, the power tool 1 configured as a screwdriver essentially includes a power tool housing 2 with a tool fitting 3 and a handle 4.

The tool fitting 3 is used to receive and retain a tool 5. The tool 5 is a screwdriver bit in the present example. Alternatively, the tool 5 can also be configured as a drill.

A drive 6, a transmission 7a, an output shaft 7b, and a control unit 8 are, inter alia, provided in the interior of the power tool housing 2. The drive 6 is configured, for example, as a brushless electric motor and serves to generate torque.

The control unit 8 controls in a closed and open loop the functions and the behavior of the power tool 1 and in particular the drive 6.

The handle 4 in turn includes an actuating switch 9, an upper end 4a, and a lower end 4b. The actuating switch 9 is connected to the control unit 8 such that actuating the actuating switch 9 results in an activation of the drive 6 or the power tool 1.

As also shown in FIG. 1, the drive 6, the transmission 7a, the output shaft 7b, and the tool fitting 3 are arranged relative to one another such that torque generated by the drive 6 can be transmitted to the tool fitting 3 via the transmission 7a and the output shaft 7b. The torque generated by the drive 6 is ultimately transmitted to the tool 5 by the tool fitting 3.

The power tool housing 2 furthermore has an upper side 2a, a lower side 2b, a front end 2c, and a rear end 2d.

The tool fitting 3 is positioned at the front end 2c. The upper end 4a of the handle 4 is fastened to the lower side 2b and in the vicinity of the rear end 2d of the power tool housing 2. A power tool interface 10 is positioned at the lower end 4b of the handle 4. The power tool interface 10 is used for releasably connecting the power tool 1 to the rechargeable battery 11.

The rechargeable battery 11 described in the exemplary embodiment can be used in particular as an energy storage apparatus or electrical energy source for the power tool 1. The rechargeable battery 11 here essentially includes a rechargeable battery housing 12, a number of energy storage cells 13, a storage apparatus 16, a rechargeable battery interface 23, and a control device 17. The energy storage cells 13 can also be referred to as rechargeable cells.

The storage apparatus 16 is positioned in the interior of the rechargeable battery housing 12 and is used to store and provide data and information.

The rechargeable battery interface 23 is used to connect the rechargeable battery 11 to the power tool 1 by means of the power tool interface 10.

The energy storage cells 13 can also be referred to as rechargeable cells and serve to receive, store, and deliver again electrical energy. As indicated in the Figures, the energy storage cells 13 are cylindrical and configured on the basis of lithium-ion technology. Alternatively, the energy storage cells 13 can also be based on another suitable technology. The cylindrical shape of the energy storage cells 13 is likewise optional such that any other suitable shape or geometry can also be selected.

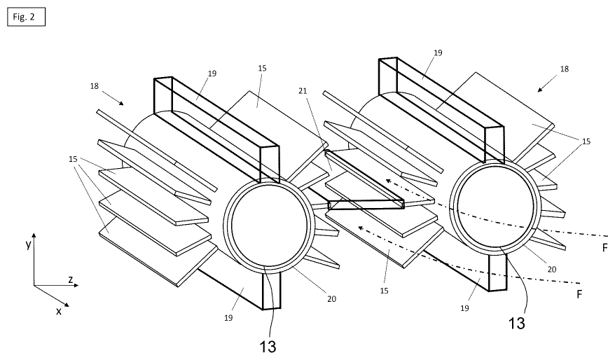

As indicated in the Figures, the rechargeable battery 11 according to the exemplary embodiments shown has a plurality of retaining devices 18 (see, e.g., FIG. 2). The retaining devices are used to receive and retain an energy storage element 13 (shown solely schematically in FIG. 2). One retaining device 18 is provided in each case for each energy storage element 13. As described below, the retaining devices 18 can be configured differently.

Retaining devices according to a first exemplary embodiment are illustrated in FIG. 2. The retaining device 18 according to the first embodiment contains a cylindrical tube 20 in which in each case one energy storage cell 13 is accommodated and retained. Two retaining devices 18 are shown in FIG. 2. A total of ten cooling elements 15 in the form of cooling ribs are arranged on an outer surface 14. In each case five cooling elements 15 configured as cooling ribs extend in a radial direction from a first and a second side face of the tube 20. A gap 21, through which a cooling fluid F (i.e. air) can flow, is provided between the retaining devices 18. The cooling elements project into the gap 21. Heat can be dissipated from the retaining device 18 or from an energy storage cell 13 which is situated in the retaining device 18 by means of the cooling elements 15. According to a first embodiment, the retaining devices 18 are positioned relative to each other in the interior of the rechargeable battery housing 12 such that the free ends of the cooling elements 15 of each retaining device 18 are not in contact with one another. As indicated in FIG. 2, the retaining devices 18 are connected to each other by means of a first connecting device 19. The first connecting device 19 is configured, according to the first embodiment of the retaining device 18, in the form of a flat plate. The first connecting device 19 configured as a plate has, at opposite side edges, a groove in which the free ends of the cooling ribs 15 can be accommodated and retained. In each case two retaining devices 18 can thus be connected to each other releasably and in force-fitting fashion in a horizontal plane. Alternatively, the free ends of the cooling ribs 15 of each retaining device 18 can also be permanently connected to the first connecting device 19. A permanent connection can, for example and in addition to a force-or form-fitting connection, also be achieved via a materially bonded connection (for example by adhesive).

A second connecting device 19 is provided at an upper end of the tube 20 of a retaining device 18 and a third connecting device 19 is provided at a lower end of the tube 20 of a retaining device 18. The second and third connecting device 19 are configured identically for the first embodiment of the retaining device 18 and are used, like the first connecting device 19 too, to connect adjacent retaining devices 18 to each other. According to a first exemplary embodiment, the second and third connecting device 19 are configured such that a lower side edge and an upper side edge each have a rail element.

By means of the rail elements, the second connecting device 19 can be connected releasably at an upper end of the tube 20 and the third connecting device 19 can be connected releasably at a lower end of the tube 20 such that adjacent retaining devices 18 can be connected vertically to each other. Instead of the rail elements, a tongue-and-groove system can also be provided in order to vertically connect the retaining devices 18 to each other by means of the second and third connecting device 19. The second and third connecting device 19 are connected together releasably by means of a force-or form-fitting connection to the tubes 20 of the retaining devices 18. As an alternative or in addition to the force-or form-fitting connection, a materially bonded connection (for example by adhesive) can also be possible.

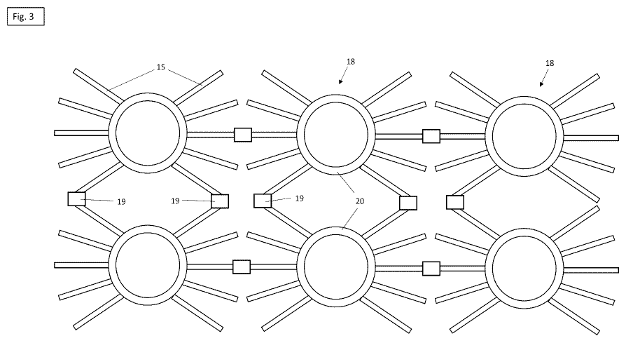

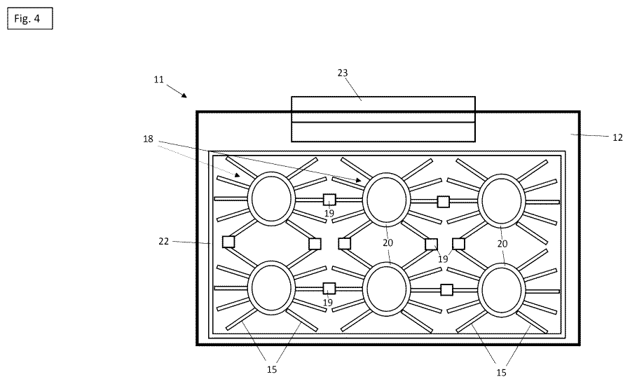

A further configuration for the connection of the individual retaining devices 18 according to the first embodiment is shown in FIGS. 3 and 4. The connection of adjacent retaining devices 18 in a horizontal plane is here effected by the first connecting device 19. The connection in the vertical plane is effected with a fourth connecting device 19 which in each case connects the free ends of the lowermost cooling elements 15 of an upper retaining device 18 to the in each case free ends of the uppermost cooling elements 15 of a lower retaining device 18. The connection of the adjacent retaining devices 18 to the fourth connecting device 19 is configured according to the exemplary embodiment shown in FIGS. 3 and 4 by a rail element or a tongue-and-groove system. The connection by the fourth connecting device 19 is here configured releasably. Alternatively or additionally, a materially bonded connection (for example by adhesive) can also be provided.

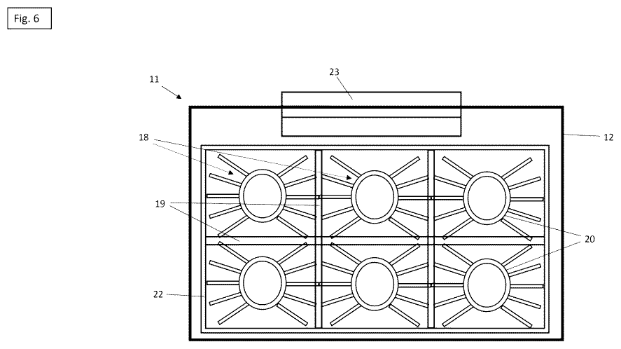

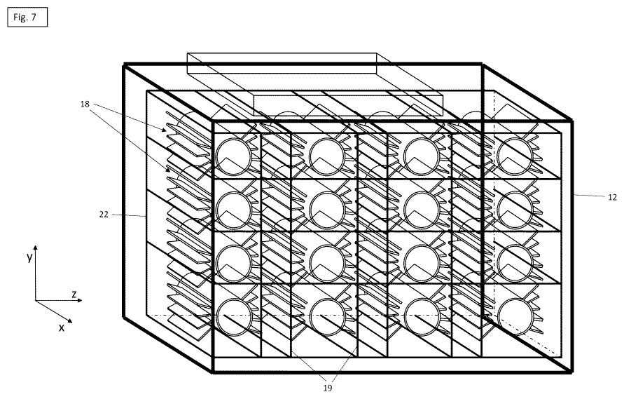

The retaining devices 18 according to the first embodiment are illustrated in the rechargeable battery housing 12 in FIGS. 6 and 7. The fifth connecting device 19 has, according to the exemplary embodiment shown in FIGS. 6 and 7, a horizontally arranged plate and a vertically arranged plate. The individual retaining devices 18 can be connected to one another both in a vertical direction y and in a horizontal direction z by means of the fifth connecting device. The connection in the vertical or horizontal plane to the fifth connecting device 19 is effected by a rail element or a tongue-and-groove system which connect the free ends of the respective cooling elements 15 of the retaining devices 18 to one another. The rail elements and tongue-and-groove system are not shown in the Figures. The connection by the fifth connecting device 19 is here configured releasably. Alternatively or additionally, a materially bonded connection (for example by adhesive) can also be provided.

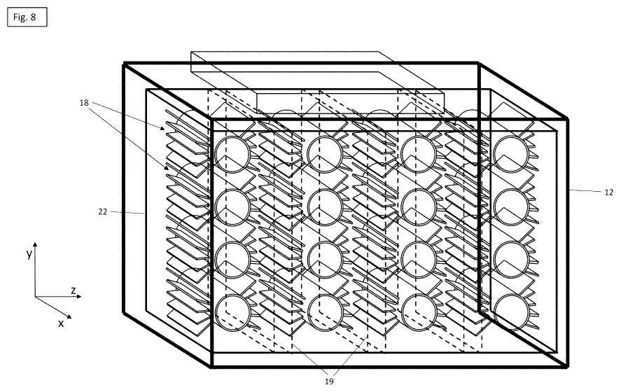

As indicated in FIG. 8, adjacent retaining devices 18 according to the first embodiment can be connected to one another vertically (in the y direction) and horizontally (in the z direction) by a sixth connecting device 19. For this purpose, the sixth connecting device 19 is configured as a plate which is elongated in the vertical direction y and extends, on the one hand, over the whole extent of the retaining devices 18 arranged one above the other and, on the other hand, over the whole length of the retaining device 18 in the direction x. The sixth connecting device 19 configured as an elongated plate has gaps 21, into which the free ends of the cooling ribs of the corresponding retaining devices are inserted, at regular intervals on both side faces. The gaps 21 can also be referred to as grooves and are not illustrated in the Figures. Alternatively, the retaining devices 18 can also be connected to the sixth connecting device 19 by a materially bonded connection (for example by adhesive) in addition to or instead of a force- or form-fitting connection (i.e. in the form of a groove).

The fifth and sixth connecting device 19 can be also be viewed in the respective embodiment as a frame apparatus 22 by means of which the retaining devices are additionally retained in the rechargeable battery housing 12.

The connecting device 19 can be connected to the inner face of the rechargeable battery housing 12. This connection can here be releasable or fixed.

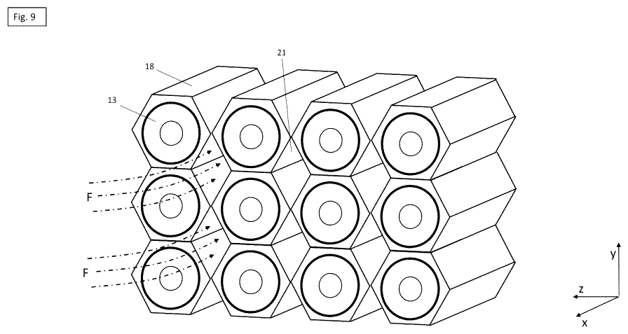

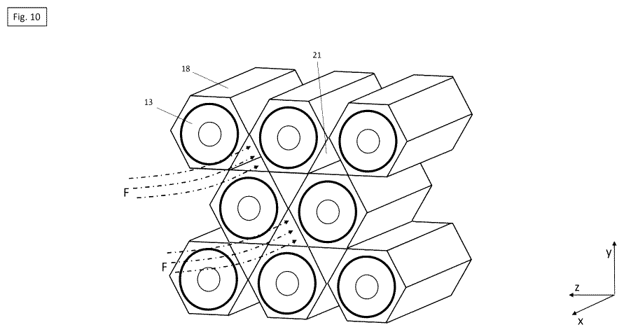

Retaining devices 18 according to a second embodiment are illustrated in FIGS. 9 and 10. In the second embodiment, the retaining device 18 has a hexagonal cross-sectional area. In the arrangement of the retaining devices 18 as shown in FIG. 9, gaps 21 (or alternatively free spaces) are provided between adjoining retaining devices 18 through which air can flow as cooling fluid F. The cross-sectional area of a gap 21 is here rectangular or in the shape of a rhombus. According to the arrangement of the retaining devices 18 as shown in FIG. 10, the cross-sectional area of the gaps 21 or free spaces between adjoining retaining devices 18 are configured as triangular.

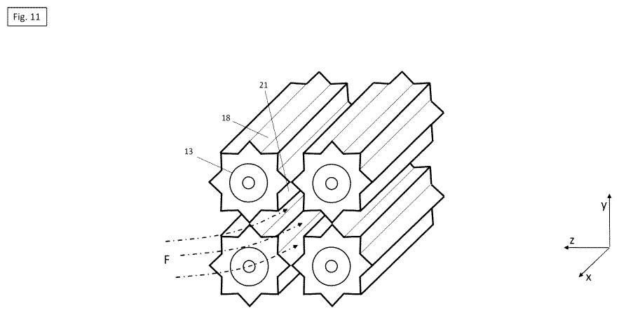

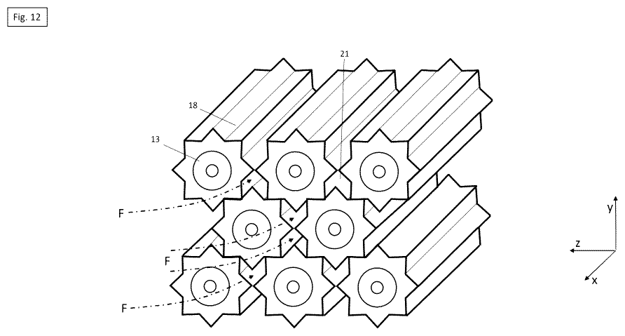

Retaining devices 18 according to a third embodiment are illustrated in FIGS. 11 and 12. In the third embodiment, the retaining device 18 has an octagonal or star-shaped cross-sectional area. The retaining devices 18 according to the third embodiment are shown in FIG. 11 in a first arrangement relative to one another. The retaining devices 18 according to the third embodiment are furthermore shown in FIG. 12 in a second arrangement relative to one another.

The retaining devices according to the second and third embodiment can also be combined with the first to sixth connecting device.

### LIST OF REFERENCE SIGNS

1 power tool
2 power tool housing
3 tool fitting
4 handle
4a upper end of the handle
4b lower end of the handle
5 tool
6 drive
7a transmission
7b output shaft
8 control unit
9 actuating switch
10 power tool interface
11 rechargeable battery
12 rechargeable battery housing
13 energy storage cells
14 outer surface
15 cooling element
16 storage apparatus
17 control device
18 retaining device
19 connecting device
20 tube
21 gap
22 frame apparatus
23 rechargeable battery interface
F cooling fluid

1-10. (canceled)

11. A rechargeable battery as an energy supply for a power tool including a first and a second energy storage element, the rechargeable battery comprising:
a first retainer for receiving and retaining the at least first energy storage element and a second retainer for receiving and retaining the at least second energy storage element, the second retainer adjacent the first retainer;
at least one subregion of an outer surface of the at least first or second retainer being configured such that at least one gap for a cooling fluid is provided between the first and second retainers.

12. The rechargeable battery as recited in claim 11 further comprising at least one frame for receiving and retaining the first and second retainers.

13. The rechargeable battery as recited in claim 12 wherein the first and second retainers are connected to each other via a connector.

14. The rechargeable battery as recited in claim 13 wherein the connector is configured such that the first and second retainers are connected releasably to each other.

15. The rechargeable battery as recited in claim 13 wherein the connector is configured such that the at least first and second retainers are connected releasably to each other.

16. The rechargeable battery as recited in claim 11 further comprising at least one cooling element at the at least one subregion.

17. The rechargeable battery as recited in claim 16 wherein the at least one cooling element is configured as a cooling rib.

18. The rechargeable battery as recited in claim 11 wherein the first or second retainers include a polygonal outer surface.

19. The rechargeable battery as recited in claim 11 wherein the first retainer has a first embodiment of a first outer surface and the at least second retaining device (18) has a second embodiment of a second outer surface.

20. A power tool comprising the rechargeable battery as recited in claim 11.
